(19) United States
(12) Patent Application Publication
(10) Pub. No.: US 2004/0239528 A1
(43) Pub. Date: Dec. 2, 2004

(54) Method and apparatus for measuring speed

(76) Inventor: Andrew Luscombe, Greensborough Vic (AU)

Correspondence Address: STITES & HARBISON PLLC, 1199 NORTH FAIRFAX STREET, SUITE 900, ALEXANDRIA, VA, 22314, US

(21) Appl. No.: 10/483,713

(22) PCT Filed: Jul. 12, 2002
(86) PCT No.: PCT/AU02/00944

(30) Foreign Application Priority Data
Jul. 12, 2001 (AU) PR 6318

(51) Int. Cl. G08G 1/04

(52) U.S. Cl. 340/942; 340/556; 250/200

(57) ABSTRACT

The invention provides a method and apparatus for monitoring a moving object, the method comprising: emitting electromagnetic radiation so that the object passes through the electromagnetic radiation; detecting a plurality of reflection events, each comprising a reflection of the electromagnetic radiation from the object; determining a direction of each of the reflection events from the direction of emission of the electromagnetic radiation or from the direction of detection of the respective reflection event; and determining the relative timing of the reflection events; wherein information pertaining to the object can be determined, the information comprising any one or more of a speed, a location and a direction of the object.

### FIELD OF THE INVENTION

The present invention relates to a method and apparatus for measuring speed, of particular but by no means exclusive application in monitoring the motion of motor vehicles. In a preferred embodiment, the invention provides a roadside sensor system for measuring the speed of motor vehicles.

### BACKGROUND OF THE INVENTION

One particular example of the use of speed measurement apparatuses is in traffic management and law enforcement, which often require that traffic be monitored on public roads for breaches of speed limits. In addition, organisations responsible for various aspects of traffic flow may desire to gather accurate information about that flow for many purposes, including planning road construction, scheduling traffic signals, managing the deployment of law-enforcement resources, and enforcing the law.

A variety of existing sensors have been in use for a number of years for measuring the speed of vehicles from remote locations, as those vehicles pass a point along the road. Many of these existing sensors require the installation of pressure-sensing strips and/or inductive wire loops in the road surface. Others send a beam of light or electromagnetic radiation towards a motor vehicle, and determine the speed based on the returned signals. Various types of devices are suitable for various applications. For example, in law-enforcement applications measurement systems with a high degree of confidence in the measured speed are required. Sometimes portability is a desired characteristic, while at other times a long and continuous functional lifetime is of prime concern.

Thus, although system requirements depend on application, existing sensor systems used in conjunction with cameras to take pictures of speeding vehicles generally aim to provide, inter alia:

a) highly reliable results,

b) appropriate positioning of vehicle within the picture (i.e. the number plate well within the camera's field of view),

c) continuous, extended unmanned operation,

d) operation on all road surfaces and types, and

e) monitoring of speed of the full range of vehicles including motorbikes and trucks.

Many systems in current use do not provide all of these characteristics. Some systems cannot be installed on certain types of road surfaces, others trigger off the front of vehicles or off the front wheels and so the position of the rear of long vehicles is out of camera shot even though the camera may view the vehicles from the rear, while others are not always triggered by very light vehicles, such as motor bikes.

### SUMMARY OF THE INVENTION

The present invention provides, therefore, a method of monitoring a moving object having a velocity, comprising:

emitting electromagnetic radiation so that said object passes through said electromagnetic radiation;

detecting a plurality of reflection events, each comprising a reflection of said electromagnetic radiation from said object;

determining a direction of each of said reflection events from the direction of emission of said electromagnetic radiation or from the direction of detection of said respective reflection event; and

determining the relative timing of said reflection events;

wherein information pertaining to said object can be determined, said information comprising any one or more of a speed, a location and a direction of said object.

Thus, the direction of a reflection event can be determined from the direction in which the radiation is emitted, or from the direction from which reflected radiation is detected. In principle, both could be used to reduce the detection of false events.

The method can also include deriving further information from said information, such as that the object has indeed passed into or through said electromagnetic radiation.

Preferably said electromagnetic radiation comprises a plurality of beams of electromagnetic radiation each having a known emission direction, wherein the direction of a reflection event is determined from said known emission directions. More preferably said method includes emitting three or more beams of electromagnetic radiation, and said velocity has a respective component parallel to each of said beams. Preferably at least one pair of said beams are non-parallel with respect to each other.

Preferably each of said beams is a spatially dispersing beam in a first plane and relatively narrow in a second plane perpendicular to said first plane. Preferably said first plane is substantially upright.

Each of said beams may be a composite beam comprising multiple sub-beams.

Alternatively, said method includes detecting said reflection events by means of a plurality of detectors each having a known detection direction, wherein the direction of a reflection event is determined from said known detection directions. More preferably said method includes detecting said reflection events by means of three or more detectors each having a known detection direction.

Preferably said each of said plurality of detectors has a detection region that is relatively broad in a first plane and relatively narrow in a second plane perpendicular to said first plane. Preferably said first plane is substantially upright.

Preferably said electromagnetic radiation is infra-red radiation. In other embodiments, however, said electromagnetic radiation is visible light or ultraviolet light.

Preferably said electromagnetic radiation is modulated so that reflected electromagnetic radiation detected from said reflection events is correspondingly modulated, and said method includes discriminating between said modulated reflected electromagnetic radiation and background or other undesired electromagnetic radiation.

Preferably said method includes DC filtering reflected electromagnetic radiation detected from said reflection events or a signal corresponding thereto, to eliminate unmodulated and therefore undesired detected electromagnetic radiation.

Preferably said method includes detecting one or more of said reflection events in the form of at least one temporal spectrum of reflected electromagnetic radiation intensity.

Thus, a particular prominent reflection event (perhaps corresponding to a reflective number plate) could be selected for use, providing a clearer indication of the passage of a particular object.

Preferably said method includes emitting said electromagnetic radiation and detecting said plurality of reflection events from respective locations of close proximity.

In one embodiment, said electromagnetic radiation is emitted from one or more sources of electromagnetic radiation, and said method includes detecting said reflection events by means of one or more detectors each having a known detection direction, wherein each of said one or more sources is located in close proximity to at least one of said detectors. More preferably said method includes detecting reflection events due to reflection of electromagnetic radiation from a respective one of said one or more sources by means of a respective one of said detectors, wherein said respective one of said one or more sources and said respective one of said detectors are in close proximity.

Preferably said method includes detecting said reflection events by means of three or more detectors.

It will be understood that a particular detector could be used as the detector for more than one source. The close positioning of the sources and detectors assists in eliminating the adverse effects of shadows and glare points. Modulating the electromagnetic radiation reduces the effects of shadows and glare points from ambient light sources, while this close positioning reduces the possibility of shadows from the sources and the negative effects of glare points (as, if viewing a scene from the only source of illumination, directly cast shadows should not be visible).

In one aspect, the invention provides a method for measuring the speed of a moving motor vehicle, according to the method described above.

The present invention also provides an apparatus for monitoring an object moving with a velocity along a path, comprising:

an electromagnetic radiation emitter for emitting electromagnetic radiation into said path;

an electromagnetic radiation detector for detecting a plurality of reflection events, each comprising a reflection of said electromagnetic radiation from said object, and outputting an output signal in response thereto; and

computation means for receiving said output signal, determining the relative timing of said reflection events and associating with each of said reflection events a direction derived from the direction of emission of said electromagnetic radiation or from the respective direction of detection of said respective reflection event.

Preferably said computation means (typically a suitably programmed computer or hardware device) is operable to determine information from at least the relative timing of said reflection events and said directions thereof, said information comprising any one or more of a speed, a location and a direction of said object.

The detector may include signal processing means for processing said output signal before outputting said output signal.

The computation means may also be operable to derive further information from said information, such as that the object has indeed passed into or through said electromagnetic radiation.

Preferably said emitter includes a plurality of electromagnetic radiation sources, each for emitting electromagnetic radiation having a known emission direction, wherein the direction of a reflection event is determinable from said known emission directions. More preferably said apparatus includes three or more electromagnetic radiation sources, and said velocity has a respective component parallel to each of said emission directions. Preferably at least one pair of said emission directions are non-parallel with respect to each other.

Preferably each of said sources emits a spatially dispersing beam in a first plane and relatively narrow in a second plane perpendicular to said first plane. Preferably said first plane is substantially upright.

Each of said beams may be a composite beam comprising multiple sub-beams.

Alternatively, said electromagnetic radiation detector comprises a plurality of photodetectors each having a known detection direction, wherein the direction of a reflection event is determinable from said known detection directions. More preferably said electromagnetic radiation detector comprises three of more photodetectors each having a known detection direction.

Preferably said each of said plurality of photodetectors has a detection region that is relatively broad in a first plane and relatively narrow in a second plane perpendicular to said first plane. Preferably said first plane is substantially upright.

Preferably said electromagnetic radiation is infra-red radiation. In other embodiments, however, said electromagnetic radiation is visible light or ultraviolet light.

Preferably said apparatus includes at least one modulator for modulating said electromagnetic radiation so that said reflected electromagnetic radiation is correspondingly modulated, and a discriminator for discriminating between said modulated reflected electromagnetic radiation and background or other undesired electromagnetic radiation.

Preferably said apparatus includes at least one DC filter for filtering said reflected electromagnetic radiation or a signal corresponding thereto, to eliminate unmodulated and therefore undesired detected electromagnetic radiation.

Preferably said apparatus is operable to detect one or more of said reflection events in the form of at least one temporal spectrum of reflected electromagnetic radiation intensity.

Preferably said emitter and said detector are located so that said reflection events are detected at respective locations in close proximity to where said electromagnetic radiation is emitted.

In one embodiment, said emitter comprises one or more sources of electromagnetic radiation, and said detector comprises one or more photodetectors each having a known detection direction, wherein each of said one or more sources is located in close proximity to at least one of said photodetectors. More preferably said apparatus is configured to detect reflection events due to reflection of electromagnetic radiation from a respective one of said one or more sources by means of a respective one of said photodetectors, wherein said respective one of said one or more sources and said respective one of said photodetectors are in close proximity.

Preferably said detector comprises three or more photodetectors.

In one aspect, the invention provides an apparatus for measuring the speed of a moving motor vehicle, including the apparatus described above.

### BRIEF DESCRIPTION OF THE DRAWINGS

In order that the present invention may be more clearly ascertained, preferred embodiments will now be described, by way of example, with reference to the accompanying drawing, in which:

FIG. 1 is a schematic view of a sensor system according to a preferred embodiment of the present invention with a typical field of view thereof, viewed from above;

FIG. 2 shows an example measurement plane angling across a road of the system of FIG. 1;

FIG. 3 shows an example minimal arrangement of measurement planes for the system of FIG. 1, viewed from above;

FIG. 4 is a signal-flow diagram showing the elements used to monitor one measurement plane by means of the system of FIG. 1, and the signals that flow therebetween;

FIG. 5 is a schematic view of the housing with cylindrical lenses, photodiodes and emitting diodes of a high precision sensor system according to a further embodiment of the present invention;

FIG. 6 is a circuit diagram of a representative trans-impedance amplifier circuit of the type to which each of the photodiodes of the system of FIG. 5 is connected;

FIG. 7 is a half circuit diagram of a representative circuit of the type to which each light emitting element of the system of FIG. 5 is connected;

FIG. 8 is a plot of a time record of a car passing through a measurement plane, measured with the system of FIG. 5; and

FIG. 9 is a schematic diagram illustrating how speed can be calculated with the system of FIG. 5.

### DETAILED DESCRIPTION

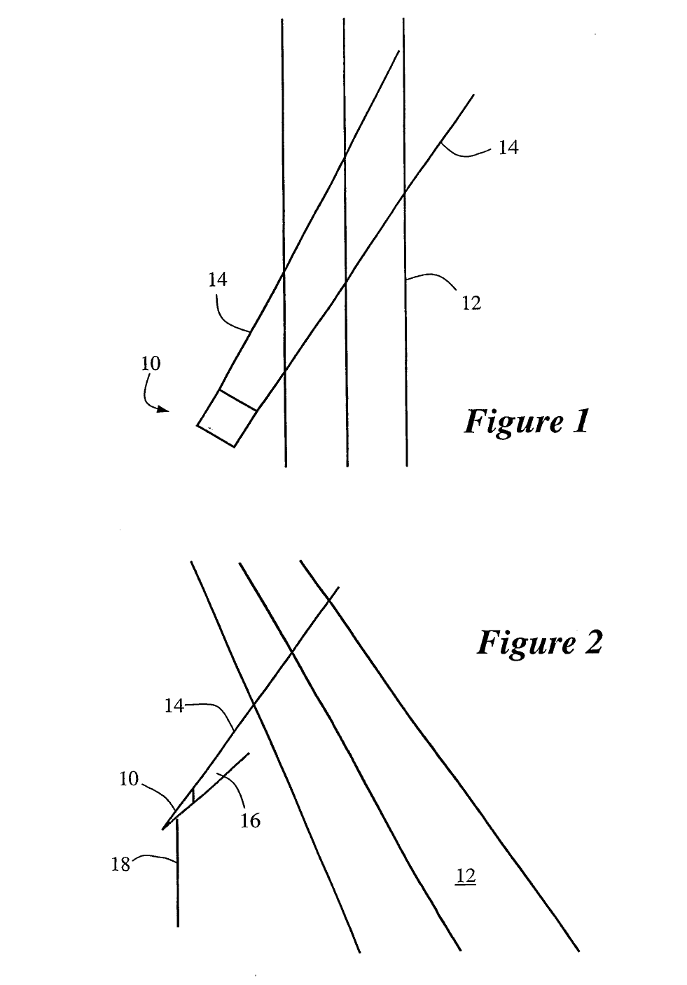

A sensor system for measuring the speed of motor vehicles according a preferred embodiment of the present invention is shown generally at 10 in situ beside a road 12 in FIG. 1 from above.

Broadly, the sensor system 10 includes a number of light-emitting elements for directing beams of light 14 towards vehicles on the road 12, light collecting elements for collecting light reflected from those vehicles and light-sensing elements for detecting the light collected by the lenses. The light collecting elements (as will be discussed in more detail below) are selected to collect or focus light substantially from the direction of one plane only. In this embodiment each comprises a cylindrical lens optically behind an aperture in the form of a vertical slit, though a cylindrical lens alone may also be suitable in some applications. The lenses, slits and light-sensing elements are arranged so that each light-sensing element receives the light from only one of the lenses, so that each light-sensing element collects light from a limited spatial region. The lenses are oriented to collect light from a detection region comprising a narrow, vertical plane, generally forward of the sensor 10. The light-sensing elements are also positioned appropriately relative to the lenses to accentuate the lateral narrowness of these detection regions. It will be understood that, although these detection regions are referred to as planar they will not be precisely so, and—indeed—each detection region requires suitable width to receive sufficient light for detection to occur. It is a straightforward matter, however, to adjust this width according to requirements, such as the sensitivity of the light-sensing elements, typical ambient lighting, distance of the sensor system 10 from the vehicles, etc. For convenience, however, the detection regions are referred to below as measurement planes; such a representative plane is shown schematically at 16 in FIG. 2, which is a perspective view equivalent to FIG. 1. Also shown in FIG. 2 is a pole 18 on which the sensor system 10 is mounted.

The system 10 is used with a computational device (typically a programmed computer: not shown) for receiving from the sensor system 10 signals indicative of the light sensed by the system 10, and performing the required analysis to determine vehicle speed. The analysis phase is also discussed in further detail below.

The light-emitting elements are located near the lenses shining towards the sensor system's field of view so that each light-sensing element is especially sensitive to retro-reflective objects in its respective measurement plane. Each light-emitting element has a control input which allows the brightness of emitted light to be controlled. This control input enables insensitivity to ambient lighting to be achieved, if it is required. When the brightness of the emitted light is varied in a known way, the computational device can distinguish between the components of the signals due to ambient light and components due to retro-reflected light from a vehicle (i.e. originating from the light-emitting elements and collected by the lenses). If only the component due to the retro-reflected light is used in calculations, then calculation of vehicle speed by the computational device is relatively simple and highly reliable. This is because retro-reflecting objects on the back and front of vehicles (viz. number plates, reflectors and the like) generally have relatively simple shapes, and the light patterns reflected by them to the sensor system 10 are also relatively simple and have a relatively straightforward dependence on vehicle speed and position.

The light-emitting elements need not have narrow beam widths (although that might be advantageous in some applications), as the narrowness of the measurement planes allows the direction of the source of reflected light to be determined to the accuracy implied by the width of each measurement plane.

Although a majority of vehicles travel straight along the road and will pass through the measurement planes at a known and constant angle, some vehicles may not. For example, vehicles might be changing lanes or swerving slightly for some other reason as they pass through the measurement planes. The use of multiple measurement planes addresses this phenomenon, angled to the first. Each measurement plane is added by adding—as required—further light-emitting devices, lenses, slits and light-sensing elements. Thus, when a second (third, etc.) light-sensing element, slit, and light-emitting element are added to the first one but offset from it to the left but so that the second measurement plane so produced is parallel to the first, the variations in light sensed by the two light-sensing elements is similar, but the second is delayed relative to the first. Knowing the distance between the measurement planes and the angle of the planes to the road, it is possible to calculate the vehicle's speed from the time delay between the two outputs of the light-sensing elements, that is, by means of a time over distance calculation.

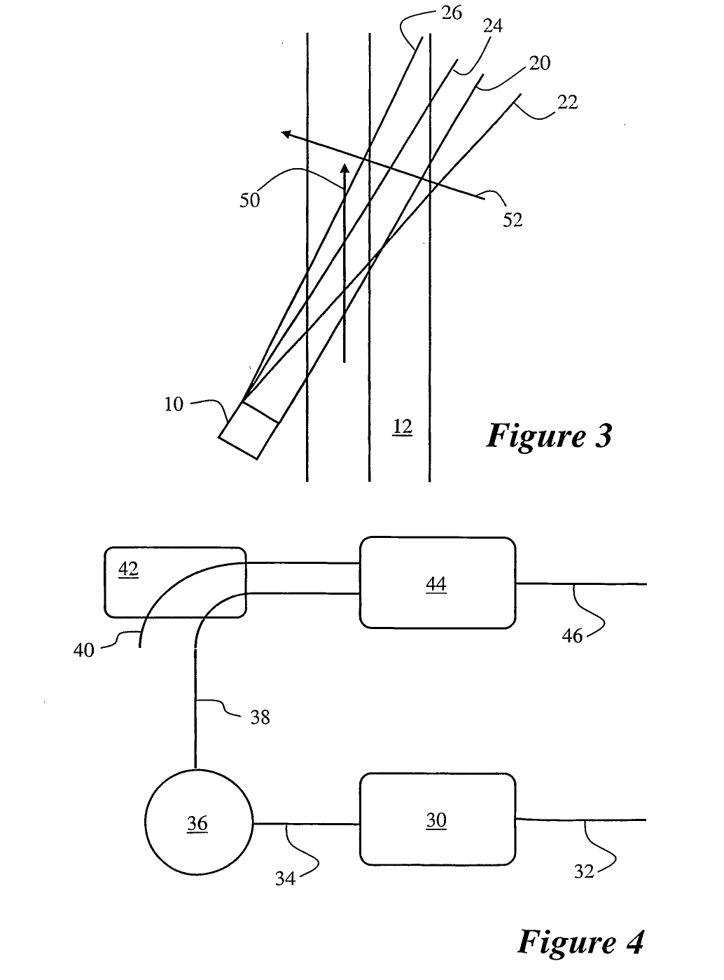

FIG. 3, therefore, is a plan view of a typical installation of the sensor system 10 with multiple measurement planes 20, 22, 24, 26; the locations of the measurement planes 20, 22, 24, 26 are determined by the physical locations of the lenses and light-sensing elements. These measurement planes 20, 22, 24, 26 define a field of view of the sensor system 10. The measurement planes 20, 22, 24, 26 are offset relative to each other by known distances and angles, and do not all intersect along a single line. This allows the time delays between the variations of light produced on each plane by a retro-reflecting object travelling through the planes to be translated into a speed, direction, and distance from the sensor system 10. The sensor system may be constructed with more than the minimum number of measurement planes mathematically necessary to perform the calculation of speed, direction, and distance to give a degree of redundancy to allow for error checking and reliability. The sensor system 10, as has been made clear, is constructed with all of its measurement planes 20, 22, 24, 26 vertical (i.e. with their normals parallel to a single plane), so that the sensor system 10 is not sensitive to the component of travel in that vertical direction; such an implementation is simpler and cheaper to construct, but it is envisaged that—if necessary—a more complex arrangement could used, possibly with additional measurement planes. This might be used for measuring airborne vehicles or objects.

The speed of a vehicle is measured as it passes through this field of view. The field of view angles across the road (as shown in FIG. 1 to 3) or—alternatively—down (i.e. essentially along) the road if the sensor system 10 is mounted above the road 12. The sensor system 10 would be far less effective when pointing directly down on traffic or directly across traffic because the number plate and reflectors are not normally visible from these positions.

The speed, direction and distance of a vehicle passing through the field of view can be determined by measuring the time for the vehicle to travel between the measurement planes 20, 22, 24, 26 within the field of view. Referring to FIG. 2, it will readily be understood that, as a vehicle travels along the road 12 and passes through the representative measurement plane 16, light falling on that plane's light-sensing element or elements due to the vehicle being a different colour and brightness from the roadway will vary. Because of the positioning of the lenses, masking slits and light-sensing elements, only the light from the measurement plane will fall on the respective light-sensing element or elements.

However, the light variation will be complex owing to several factors. One of these factors is shadows from nearby moving vehicles falling on the vehicles being detected. Such shadows produce moving patterns of light that are in many ways similar to those of the vehicle being measured, but the patterns will move at a speed determined by the vehicle casting the shadow rather than from the vehicle being monitored. Also, there may be light from nearby bright lights reflected off the vehicle, that is, “glare points”. Although glare points are lights reflected from the vehicle, they normally move at a different speed from that of the vehicle. Their motion is a property of several variables including the position of the light source, which may itself comprise the headlights of another moving vehicle, the position of the light-sensing element, and the shape and motion of the vehicle being monitored. These complex variations of light patterns due to factors other than the vehicle's speed can create problems in reliably processing the signals.

To avoid these potential problems, the light-emitting elements have control inputs designed to allow distinct temporal variations in brightness to be emitted by them so that the components of the signals sensed by the light-sensing elements due to the light-emitting elements can be identified and distinguished from the components due to ambient lighting. The reflection of the light from the light-emitting elements back to the sensor system is analogous to the transmission stage of many modulation schemes used in radio and other electronic and optical communication systems. FIG. 4 illustrates this situation schematically. In FIG. 4, a light-emitting element 30 is controlled by means of a control input 32. The light-emitting element 30 directs light 34 into the field of view and reflected from a vehicle in the field of view according to its reflectivity. This leads to a multiplication 36 (by a factor less than 1) of the initial light signal, depending on that reflectivity. The resulting light signal 38, as well as light from other sources 40, are collected by the masked lens 42, and transmitted to the light-sensing element 44. The light-sensing element 44 then outputs an output signal 46.

Thus, a proportion of the light emitted by the light-emitting elements 30 is reflected to the light-sensing elements 44 by objects intersected by—or passing through—the measurement planes. For each measurement plane 20, 22, 24, 26, this proportion varies as objects move through a measurement plane, and this proportional reflection 36 corresponds to the multiplication stage in many modulation schemes, such as Amplitude Modulation (as used in AM radio), Pulse Amplitude Modulation, and various Spread Spectrum modulation schemes in which the carrier wave has a relatively complex variation in time. The difference between the various modulation schemes applicable to the present sensor system 10 is the shape of the carrier waveforms. The carrier waveform of a modulation scheme corresponds to the signals supplied to the control inputs 32 of the light-emitting elements 30, the modulation scheme's signal waveform corresponds to the variation in reflectivity of the measurement plane as objects pass through it, and the modulation scheme's transmission waveform corresponds to the signals output 46 by the light-sensing elements 44. Background noise in the electromagnetic spectrum of the modulation scheme corresponds to light sources 40 other than light-emitting elements 30 of the sensor system 10.

Because the light-emitting elements 30 have control inputs 32, the sensor system 10 can support whichever modulation scheme is most appropriate for the application. For example, in an application for gathering approximate traffic-flow statistics at many points along a road, it may be appropriate to reduce costs by implementing a simple modulation scheme such as Amplitude Modulation, even though it may be susceptible to a degree of interference. In a law-enforcement application, it will be appropriate to implement a highly secure and reliable type of modulation, such as one of the spread-spectrum types, even though it may add cost to the system.

Returning to FIG. 3, an arrangement with four measurement planes 20, 22, 24, 26 viewed from above, the two measurement planes 22 and 24 are at angles to the first two 20, 26, and it is possible to calculate the angle and position of the path of a point on the vehicle that produces a distinct variation in retro-reflected light as it travels through the field of view. This can be seen by referring to the two paths drawn in FIG. 3, first path 50 (parallel to the road) and second path 52 (oblique to the road). If first path 50 is followed by a vehicle, it can be seen that the measurement planes are crossed in a particular order (viz. 20, 22, 24, 26) with a particular ratio of distances between the crossing points. If second path 52 is followed, both the order of the crossing points (viz. 22, 20, 24, 26) and the ratio of distances between crossing points is different. It can also be seen that if first path 50 is maintained parallel to the road but moved across the road in either direction (i.e. to be either closer to or further from the sensor system 10), the distance between the crossing point of planes 20 and 22 (“Distance 20-22”) changes although that between planes 20 and 26 (“Distance 20-26”) does not. In fact (Distance 20-22)/(Distance 20-26) is proportional to the distance across the road between first path 50 and the crossing point of planes 20 and 22. A similar situation exists for (Distance 24-26)/(Distance 22-26), which is proportional to the distance across the road between first path 50 and the crossing point of planes 24 and 26, which is in fact at the sensor system 10.

Examples of points on a vehicle that produce a distinct variation in retro-reflected light are the edges of reflectors and number plates. As the edge of a reflector or number plate passes through each measurement plane, there will be a sharp jump in the amount of light reflected back to the sensor system. A computational device receiving the signals from the sensor system can use these sharp jumps to identify such points. A degree of error checking is provided with four measurement planes because there will be more than one point on the vehicle producing a distinct variation in retro-reflected light. Number plates and reflectors have more than one edge, and there are normally two reflectors and a number plate on the rear of a vehicle. This multiplicity of edges presents an opportunity to make several speed and path measurements for each vehicle, and the several measurements so produced can be used for cross checking. Even so, to allow a higher degree of error checking to be performed, the sensor system can be constructed with more than the minimum number of measurement planes. These will provide extra information to any computational device receiving signals from the sensor system, and so further cross checking can be performed. By the addition of ever more measurement planes, it is possible to provide for an increasing degree of error checking and certainty of measurement results, although it is envisaged that no more than six measurement planes would ever be needed if a single motor vehicle speed measurement is all that is required.

It is also possible to use extra measurement planes to track the speed of a vehicle, that is, to measure that speed multiple times over a distance of several or more metres as the vehicle travels through the field of view. In an implementation for tracking, the field of view will generally be larger than one for taking a single speed measurement per vehicle. This can be achieved by designing the position of the light-sensing elements and lenses so that the measurement planes are more spread out. One application of a tracking sensor is in checking if vehicles stop at a stop sign, or slow down appropriately at a give-way or yield sign. By tracking vehicle speed for a few metres around the vicinity of the sign, in many cases it will be possible to determine if the vehicle was driven dangerously or illegally.

A detailed description is now provided on a high precision sensor system according to the present invention, particularly adapted for measuring vehicle speed in applications (such as traffic speed enforcement) requiring a high degree of confidence in each measurement. In such applications, it is not necessary that every passing vehicle be measured, but rather that there be a high degree of confidence in any measurement that is made.

The sensor system of this embodiment has six measurement planes to produce signals suitable for calculations of vehicle parameters (speed, vehicle path, and direction) in the two dimensions parallel to a road surface. Signals pertinent to the vertical direction are not produced, although other implementations of the device could produce such measurements. Though four measurement planes might suffice in this embodiment, six planes are included in order to produce redundant signals. These redundant signals enable a degree of cross checking and confirmation in any calculations carried out on the signals, and this increases confidence in the calculation results.

The basic elements of the sensor system of this embodiment are comparable to those of the above sensor system 10, but are described for this embodiment in detail as follows.

The sensor system includes two lenses that focus substantially in one direction only, each of which has three light sensing elements for detecting light passing through the respective lens. Each lens is glass with a cylindrical focussing surface with a focal length of 150 mm, and rectangular in profile (50 mm×25 mm×3.5 mm thick), with the long dimension parallel to the axis of the cylindrical surface. Glass cylindrical lenses have the advantage of ready availability, but other arrangements could be used, including slits, cylindrical mirrors or suitable Fresnel lenses, as well as alternative shapes of glass lenses and mirrors, provided that light is gathered substantially more in one direction than the other. Failure to do this will result in the measurement planes being relatively thick, and less useful for the timing and locating purposes. In this embodiment, the planes may be around 600 mm thick at the more remote vehicles. They could be wider still (with particular wide roads, for example) and the sensor system device could still produce useful results, but the system would thereby be less than optimal. Each application of the system will impose its own constraints on plane thickness.

The optical demands placed on the cylindrical lenses are less than, for example, imaging applications so lenses constructed for imaging applications will generally be satisfactory.

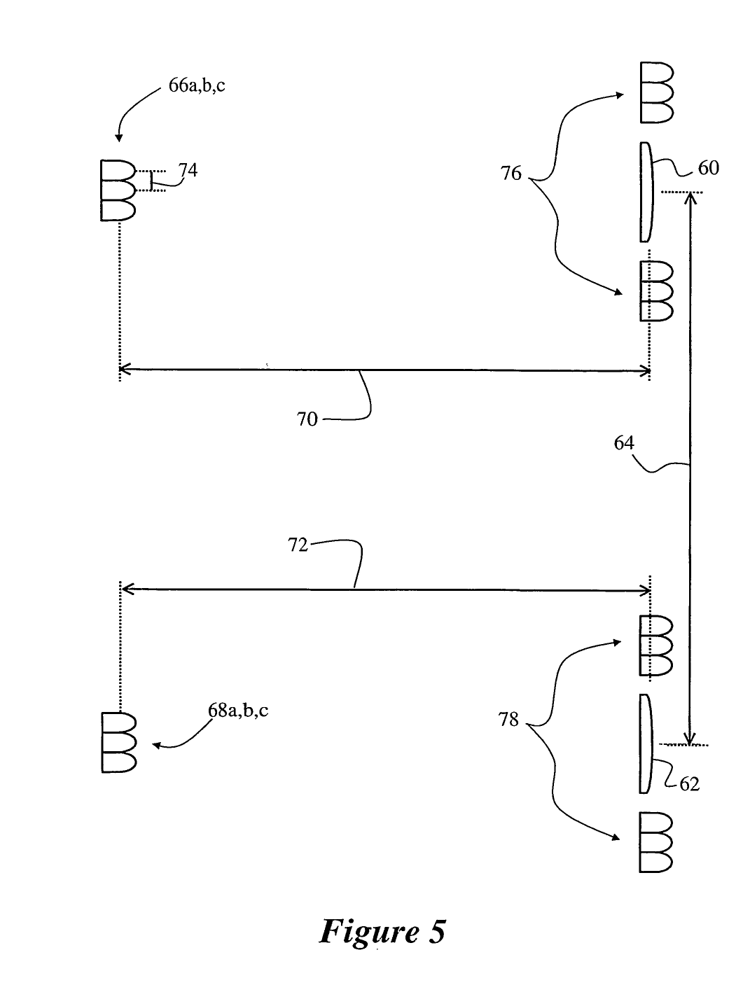

Referring to FIG. 5, which is a schematic view of the interior of the housing of this sensor system, the cylindrical lenses 60, 62 are held by the housing and fixed in position relative to each other. The axes of their cylindrical surfaces are vertical (out of the page in FIG. 5) and parallel to each other. The lenses 60, 62 are therefore held at the same distance above the ground, with a separation 64 of 700 mm. The lenses are oriented so that their main focal axes are substantially parallel to each other and approximately perpendicular to the line between them. The alignment between the axes of the cylindrical surfaces of the two lenses is important: the vertical alignment of the measurement planes is primarily determined by the alignment of these axes and, according to this embodiment, to calculate the required parameters of vehicle travel it is assumed that the distances between the measurement planes do not vary in the vertical direction. The axes should not deviate from each other by more than a centimetre over a distance of two metres along the axes (i.e. 0.25 mm within the length of the lenses), or this inaccuracy will become the dominant one in any calculations based on the outputs of the sensor system.

The other alignment requirements are less critical. Miss-alignment of the two axes of the cylindrical surfaces with the vertical about a horizontal axis in the direction of the cylindrical lens's direction of focus results in a speed calculation error proportional to the sine of the angle. This is true even though the two axes of the cylindrical surfaces may be exactly parallel with each other. Alignment within 8 degrees of the vertical will result in an error in any speed calculations of less than one percent. For the remaining positioning parameters, accuracy must be sufficient to allow all measurement planes to be positioned so that typical vehicles will travel through all of them within a quarter of a second or so. The distance between the lenses is a trade off between having a compact housing and providing space between measurement planes for sufficiently long delays between the signals from each measurement plane. What is sufficient depends on many factors including the capability of any device processing the signals to calculate speeds, and on the width of the planes themselves. Any distance between 0.5 and 1 m is adequate for this application. With different electronics and other applications, any distance from millimetres to tens of metres might be appropriate. Gross deviations in lens positioning from that described above might result in a system with measurement planes that typical vehicles cannot travel through (such as pointing the lenses away from each other, aiming them too high, or placing them at grossly different heights), which clearly should be avoided.

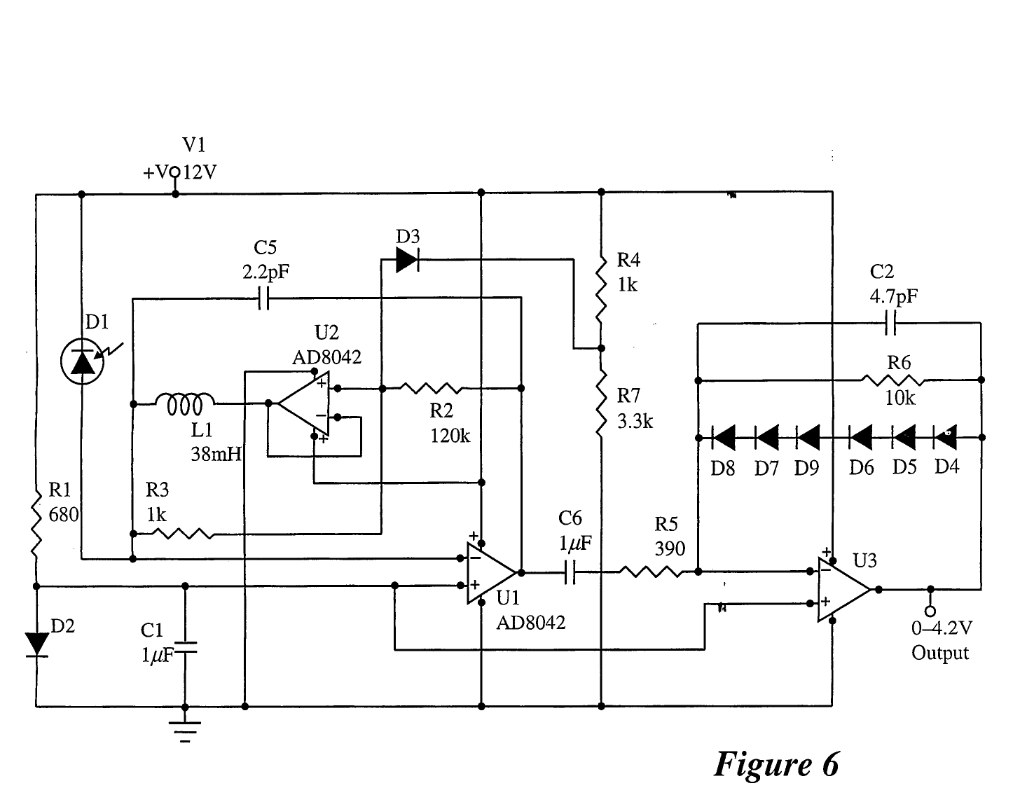

The sensor system has, also within the housing, six light sensing elements 66a,b,c and 68a,b,c. Each of these consist of one photodiode (such as a SFH213FA) connected to a trans-impedance amplifier circuit as shown in FIG. 6. The amplifier together with the photodiode package forms the light-sensing element. The SFH213FA has a spherical lens as part of its package. This lens does not interfere with the cylindrical lenses 60, 62 (described below) and in fact aids the overall performance of the system. Additional similar lenses may be fixed in front of the photodiodes to further aid in gathering light, or if photodiodes packaged without lenses are used. Such lenses are considered to be part of the light-sensing elements. It should be noted, however, that the thickness of the measurement planes at the vehicles increases proportionally with an increase in this lens diameter (all other things being held constant), and so a lens with not too large a diameter relative to the other components should be used. The SFH213FA package is suitable as manufactured without additional lenses. Each SFH213FA package should be aimed and fixed in position to receive the bulk of their incident light from the respective cylindrical lens 60 or 62. They should be positioned one focal length (of cylindrical lenses 60, 62) behind cylindrical lenses 60, 62, that is, the distance 70, 72 from the lenses 60, 62 should be equal—to within a few millimetres—to the focal length (150 mm) of lenses 60, 62. If closer or further from the cylindrical lenses 60, 62, the measurement planes will become progressively out of focus, and in effect the measurement planes will become wider (as occurs when increasing the diameter of the photodiode package lens). A small degree of de-focus is acceptable since the measurement planes have a finite thickness, but if the measurement plane thickness is increased too much, there can be difficulties in making time calculations. For each cylindrical lens 60, 62, the three photodiodes 66a,b,c and 68a,b,c respectively are positioned in a horizontal line centred at 5 mm intervals 74 and level with the middle of the cylindrical lens. This is to give an appropriate spread of the measurement planes at the traffic. The photodiodes should be placed to position the measurement planes so that they overlap the three measurement planes from the other cylindrical lens somewhere in the-vicinity of the traffic.

Referring to FIG. 6, the amplifier circuit is designed to amplify frequencies in the band 50 khz to 1 Mhz and not pass DC signals. This makes the sensor system insensitive to sunlight and most other ambient light likely to be encountered. The system can still be useful operating in other frequency bands, and even with DC levels passed. It is possible that any devices to which the sensor system is connected can perform further filtering of the signals, and in fact other devices could perform any filtering required. In this embodiment, the band was chosen to avoid large DC signals, primarily from the sun, from swamping the output signals, and using up the output voltage range. The final signal to noise ratio with the particular configuration of components used was appropriate when designed for this band.

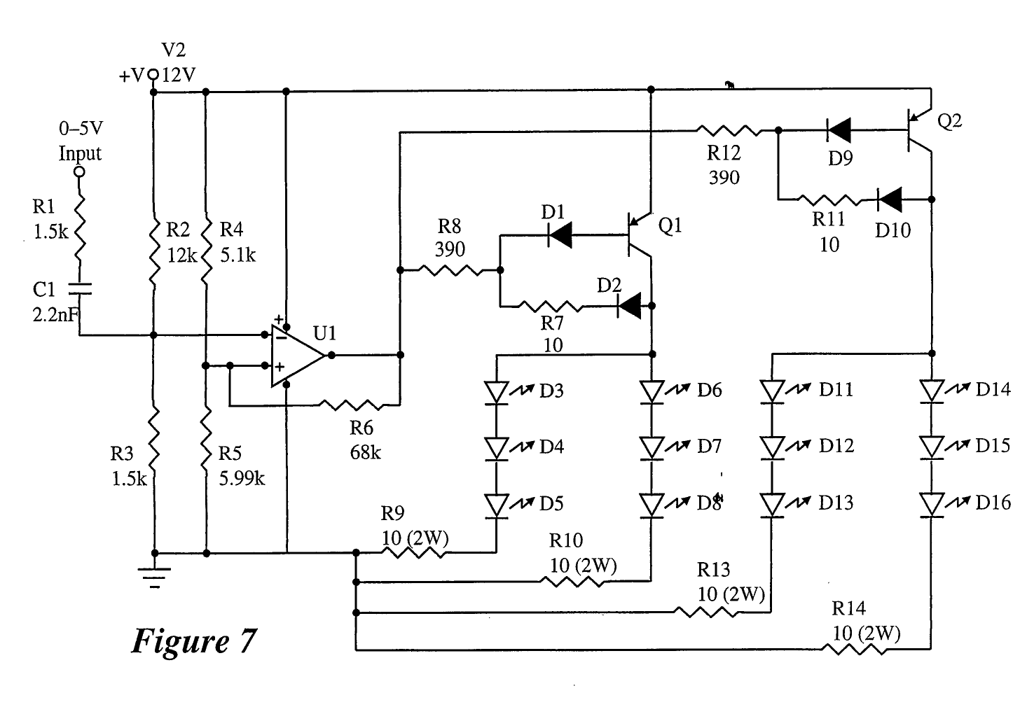

Also within the housing are two light emitting elements 76 and 78; each straddles a respective cylindrical lens 60, 62. Each light emitting element 76, 78 comprises 24 HSDL-4230 infra-red emitting diodes, 12 on each side of the respective cylindrical lens and arranged in four rows of three (one of which rows of three diodes is visible in FIG. 5 either side of each cylindrical fens). These are driven by the circuitry, half of which is shown in FIG. 7 (the other half being identical). The emitting diodes are aimed parallel to the focusing direction of the cylindrical lenses (to the right in FIG. 5), that is, at the traffic, and are fixed in position. It is possible to fix a cylindrical lens in front of these emitting diodes in a way that focuses the light into the measurement planes, rather than allow it to spread out and merely include—and thereby illuminate—the measurement planes. The number of emitting diodes could then be reduced. This will result in less total infra-red light being emitted which may make it more difficult for a driver to detect—and thereby avoid—the sensor system. The measurement planes can also be further narrowed if the emitted light is focussed to a width comparable to the measurement planes or less. It is even possible to use the directional nature of the transmitted light as the prime means of forming the measurement planes, rather than relying instead on the known direction of detected light.

The light emitting elements 76, 78 draw relatively large currents when pulsed on, and there is a possibility that a small ripple voltage may appear on the power supply depending on the supply's characteristics. This can reduce the accuracy of the light sensitive elements if they are also powered directly by the same supply. Adequate filtering or separate supplies should be used if this is found to be a problem.

The housing should be situation so that light from the light-emitting elements 76, 78 reaches the light sensing elements 66a,b,c and 68a,b,c primarily by shining out into the area of the roadway and reflecting back through the cylindrical lenses 60, 62 onto the light sensing elements 66a,b,c and 68a,b,c. If a small amount of light travels directly onto the light sensing elements 66a,b,c and 68a,b,c (that is, backwards from the light-emitting elements 76, 78), that light will add a small constant value to the signals output by the light sensing elements 66a,b,c and 68a,b,c. This should not be of great importance, but—depending on the application—if the direct light is many times that of the reflected light it may make the signals from the roadway difficult to detect and the system less useful. In this embodiment, the light-emitting elements 76, 78 are only 150 mm away from the light-sensing elements 66a,b,c and 68a,b,c, so—as the traffic may be only 8 or 12 metres away, it is preferred that measures be taken to block such direct light before it reaches the light-sensing elements 66a,b,c and 68a,b,c. Such light, it should be noted, includes light that reaches the light-sensing elements 66a,b,c and 68a,b,c by diffusing through circuit boards or leaking through cracks. This problem is readily avoided by providing, within the housing, suitable baffles or light insulation between the light-sensing elements 66a,b,c and 68a,b,c and the light-emitting elements 76, 78.

To use the sensor system in roadside speed calculations, the sensor system should be controlled and monitored. Its light-emitting elements 76, 78 have control inputs, and the signals from the light-sensing elements 66a,b,c and 68a,b,c need to be monitored. In this embodiment, the light-emitting elements 66a,b,c and 68a,b,c are designed to be pulsed on briefly. This enables a scheme analogous to pulse amplitude modulation to be used. The controlling electronics can signal either light-emitting element 76 or 78 to pulse at any time, and the amplitude of the resulting pulse output by the relevant light-sensing elements 66a,b,c, 68a,b,c indicates the proportion of pulsed light retro-reflected by any objects in the area of the roadway. A micro-controller is connected to the sensor system, which periodically signals the light-emitting elements 76, 78 to pulse, and then samples the pulses output by the light-sensing elements 66a,b,c, 68a,b,c using an analogue to digital converter. In this way, records over time of the retro-reflectivity of the objects in each measurement plane as the objects pass through the measurement plane are stored in the micro-controller's memory. The micro-controller then analyses them and determines the times at which highly reflective objects enter each measurement plane, and from these times calculates vehicle speed.

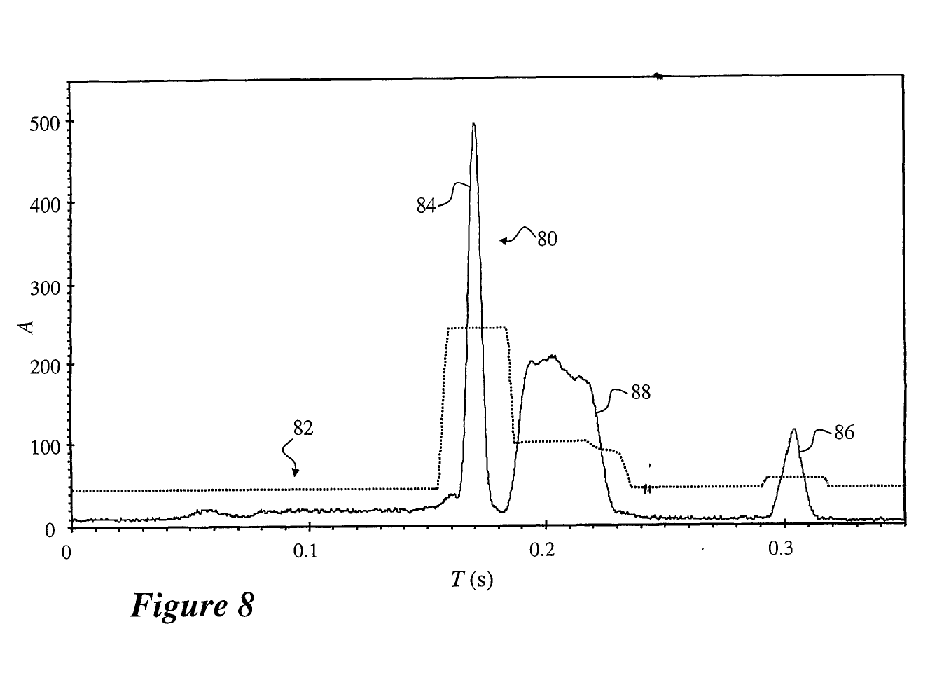

FIG. 8 shows an example time record of a car (a white station wagon/estate) passing through a measurement plane, plotted as amplitude A versus time T in seconds. The waveform drawn as a solid curve 80 is the measured signal (median of 9 samples) coming from the measurement plane. The waveform drawn with broken curve 82 is the dynamic threshold value calculated according to the peak timing algorithm presented in Table 1. The three largest measured peaks 84, 86, 88 in the solid curve 80 are produced respectively by the two rear reflectors that are part of the tail-light assemblies on each side of the vehicle, and the number plate. The number plate on this vehicle was mounted left of centre, so the peak 88 due to the number plate is not centred between the other two narrower peaks 84, 86. The bulk of the vehicle is not especially retro reflective (and certainly not as retro reflective as are the reflectors and number plates), so it has little effect on the waveforms. This waveform contains the complete record of the full length of the vehicle as it travelled through the measurement plane. Although many suitable algorithms are available for determining the time at which peaks or pulses occur in signals, and in this case for monitoring signals from the roadside sensor, that used in the system of this embodiment is summarized in simplified form in Table 1. In Table 1, therefore, arrays are assumed to be of infinite size. In practice, some management of the arrays and array indexes will be required to prevent the micro-controller's memory from filling up. Also, the most computationally efficient way of implementing the algorithm has not been described. As it is described in Table 1, many operations are repeated that in practice need not be. This has been done for clarity in describing the algorithm. The algorithm can be varied to suit different applications. The minimum threshold value can be varied, the number of array values used to calculate the averages and medians can be varied, sample times varied, and so on.

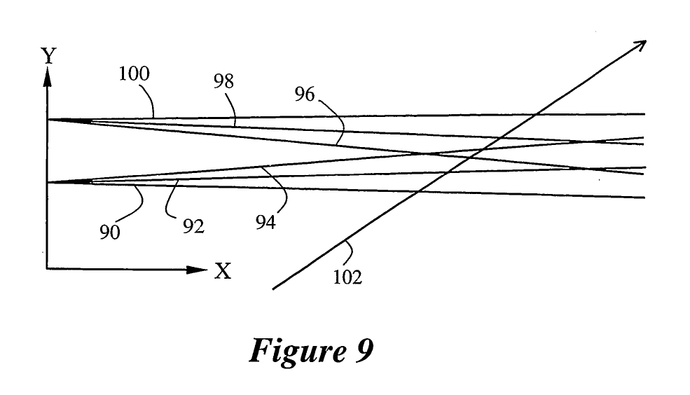

Speed is calculated as follows. FIG. 9 shows an arrangement of measurement planes 90 to 100 viewed from above, and a path 102 taken across them by a trigger point on a vehicle.

If an X axis is defined orthogonal to the Y axis in FIG. 9 (both axes being in the plane of the road), points on the measurement planes 90 to 100 satisfy the following equations:

y=a₁x for plane 90

y=a₂x for plane 92

y=a₃x for plane 94

y=a₄x+c for plane 96

y=a₅x+c for plane 98

y=a₆x+c for plane 100

and for the path of the trigger point:

y=Ax+C,

i.e. the path is assumed to be straight.

All of the above equations are linear and, provided that the trigger point on the vehicle travels at constant speed past the measurement planes, the following equation holds:

$${X}_{i} = \frac{- \frac{{T}_{i j}}{{T}_{i m}} {a}_{k j} {c}_{i m} - \frac{{T}_{i j}}{{T}_{i k}} {a}_{jm} {c}_{ik} - {a}_{mk} {c}_{ij}}{\frac{{T}_{i j}}{{T}_{i m}} {a}_{k j} {a}_{i m} + \frac{{T}_{i j}}{{T}_{i k}} {a}_{jm} {a}_{ik} + {a}_{mk} {a}_{ij}}$$

where: Xᵢ is the x coordinate of the point at which the trigger path crosses the ith measurement plane; the double subscript notation refers to a difference between the respective value (e.g. aₖⱼ=aⱼ−aₖ); Tᵢ Tⱼ Tₖ and Tₘ are the times at which the trigger point crossed each of four different planes i, j, k, and m; and Cᵢ is either c or 0 depending on which measurement plane the i refers to.

All six of the x coordinates are calculated by selecting appropriate sets of four times as measured according to the algorithm described in Table 1. The a and c values are a function of the sensor geometry and are stored in the memory of the micro-controller ready to use. From the X coordinates, the Y coordinates can be calculated using the measurement plane equations:

Yᵢ=aᵢXᵢ+cᵢ

and then the distances using the following:

Dᵢⱼ=\sqrt{(Yⱼ−Yᵢ)²+(Xⱼ−Xᵢ)²}

and speed v from the following:

$$v = \frac{{D}_{i j}}{{T}_{i j}}$$

If a number of speeds are calculated from different sets of four measurement planes selected from the six measured times, the speeds can be checked for consistency. If a set of six time measurements results in several inconsistent speed values then there may have been interference or the assumptions about constant vehicle speed and direction as it crossed the measurement planes may have been violated. Either way, the speed measurements can be regarded as suspect and not recorded for future use. If the speeds are consistent, then there can be a high degree of confidence that there was no interference, and the vehicle did travel at constant speed and direction.

TABLE 1
Peak Timing Algorithm

| | |
|---|---|
| for mp = 1 to 6 | // mp = measurement plane number |
| { | |
| trigger_valid[mp] = 0; | |
| } | |
| nt = 0; | // nt = number of trigger values |
| | recorded repeat while speeds |
| | need to be calculated |
| { | |

| wait for the next sample period; | |
|---|---|
| i = i+1; | |
| for mp = 1 to 6 | |
| { | |
| sample[mp] [i] = | (the value from the analogue to |
| | digital converter that monitors the |
| | measurement plane signal specified |
| | by the value of mp as the |
| | appropriate light emitting elements |
| | are pulsed); |
| j = i−132; | |

| for k = j−128 to j+128 | |
|---|---|
| { | |
| med_9[mp] [k] = | (the median value of the 9 values |
| | from the sample array with |
| | indexes of [mp] [k−4] to |
| | [mp] [k+4]); |
| } | |
| for k = j−119 to j+119 | |
| { | |
| ave_19 [mp] [k] = | (the arithmetic average of the |
| | 19 values from the med_9 array |
| | with indexes of [mp] [k−9] to |
| | [mp] [k+9]); |
| } | |
| threshold[mp] [j] = | (the maximum value of the 239 |
| | values from the ave_19 array |
| | with indexes of [mp] [j−119] to |
| | [mp] [j+119])/2; |

```
    if threshold[mp] [j] < (the minimum threshold value)
      {
      threshold[mp] [j] = (the minimum threshold value);
      }
    if trigger_valid[mp] equals 0
      {
      if ave_19[mp] [j] > threshold[mp] [j]
        {
        trigger_time[mp] = j;
        trigger_valid[mp] = 1;
        nt = nt+1;
        }
      }
    }
  if nt equals 6
    {
    calculate the speed from the trigger_time array
    values;
    for mp = 1 to 6
      {
      trigger_valid[mp] = 0;
      }
    nt = 0;
    }
  }
```

Modifications within the spirit and scope of the invention may be readily effected by those skilled in the art. For example, although the word light has been used above with the technical meaning as commonly used in the fields of physics and engineering (that is, visible light), the invention may also be implemented with other forms of electromagnetic radiation such as infrared and ultraviolet light. Therefore, in particular implementations of the sensor system, the light-emitting elements may emit infrared or ultraviolet light and the light-sensing elements may sense infrared or ultraviolet light. It is to be understood, therefore, that this invention is not limited to the particular embodiments described by way of example hereinabove.

1. A method of monitoring a moving object having a velocity, comprising:
emitting electromagnetic radiation so that said object passes through said electromagnetic radiation;
detecting a plurality of reflection events, each comprising a reflection of said electromagnetic radiation from said object;
determining a direction of each of said reflection events from the direction of emission of said electromagnetic radiation or from the direction of detection of said respective reflection event; and
determining the relative timing of said reflection events;
wherein information pertaining to said object can be determined, said information comprising any one or more of a speed, a location and a direction of said object.

2. A method as claimed in claim 1, including deriving further information from said information, such as that the object has indeed passed into or through said electromagnetic radiation.

3. A method as claimed in claim 1, wherein said electromagnetic radiation comprises a plurality of beams of electromagnetic radiation each having a known emission direction, wherein the direction of a reflection event is determined from said known emission directions.

4. A method as claimed in claim 3, wherein said method includes emitting three or more beams of electromagnetic radiation, and said velocity has a respective component parallel to each of said beams.

5. A method as claimed in claim 3, wherein at least one pair of said beams are non-parallel with respect to each other.

6. A method as claimed in claim 3, wherein each of said beams is a spatially dispersing beam in a first plane and relatively narrow in a second plane perpendicular to said first plane.

7. A method as claimed in claim 3, wherein each of said beams is a composite beam comprising multiple sub-beams.

8. A method as claimed in claim 1, including detecting said reflection events by means of a plurality of detectors each having a known detection direction, wherein the direction of a reflection event is determined from said known detection directions.

9. A method as claimed in claim 8, including detecting said reflection events by means of three or more detectors each having a known detection direction.

10. A method as claimed in claim 9, wherein each of said plurality of detectors has a detection region that is relatively broad in a first plane and relatively narrow in a second plane perpendicular to said first plane.

11. A method as claimed in claim 10, wherein said first plane is substantially upright.

12. A method as claimed in claim 1, wherein said electromagnetic radiation is infrared radiation or visible light or ultraviolet light.

13. A method as claimed in claim 1, including modulating said electromagnetic radiation so that reflected electromagnetic radiation detected from said reflection events is correspondingly modulated, and discriminating between said modulated reflected electromagnetic radiation and background or other undesired electromagnetic radiation.

14. A method as claimed in claim 1, including DC filtering reflected electromagnetic radiation detected from said reflection events or a signal corresponding thereto, to eliminate unmodulated and therefore undesired detected electromagnetic radiation.

15. A method as claimed in claim 1, including detecting one or more of said reflection events in the form of at least one temporal spectrum of reflected electromagnetic radiation intensity.

16. A method as claimed in claim 1, including emitting said electromagnetic radiation and detecting said plurality of reflection events from respective locations of close proximity.

17. A method as claimed in claim 1, wherein said electromagnetic radiation is emitted from one or more sources of electromagnetic radiation, and said method includes detecting said reflection events by-means of one or more detectors each having a known detection direction, wherein each of said one or more sources is located in close proximity to at least one of said detectors.

18. A method as claimed in claim 17, including detecting reflection events due to reflection of electromagnetic radiation from a respective one of said one or more sources by means of a respective one of said detectors, wherein said respective one of said one or more sources and said respective one of said detectors are in close proximity.

19. A method as claimed in claim 17, including detecting said reflection events, by means of three or more detectors.

20. A method for measuring the speed of a moving motor vehicle, including the method of claim 1.

21. An apparatus for monitoring an object moving with a velocity along a path, comprising:
an electromagnetic radiation emitter for emitting electromagnetic radiation into said path;
an electromagnetic radiation detector for detecting a plurality of reflection events, each comprising a reflection of said electromagnetic radiation from said object, and outputting an output signal in response thereto; and
computation means for receiving said output signal, determining the relative timing of said reflection events and associating with each of said reflection events a direction derived from the direction of emission of said electromagnetic radiation or from the respective direction of detection of said respective reflection event.

22. An apparatus as claimed in claim 21, wherein said computation means is operable to determine information from at least the relative timing of said reflection events and said directions thereof, said information comprising any one or more of a speed, a location and a direction of said object.

23. An apparatus as claimed in claim 21, wherein said computation means is operable to derive further information from said information, such as that the object as indeed passed into or through said electromagnetic radiation.

24. An apparatus as claimed in claim 21, wherein said emitter includes a plurality of electromagnetic radiation sources, each for emitting electromagnetic radiation having a known emission direction, wherein the direction of a reflection event is determinable from said known emission directions.

25. An apparatus as claimed in claim 24, wherein said apparatus includes three or more electromagnetic radiation sources, and said velocity has a respective component parallel to each of said emission directions.

26. An apparatus as claimed in claim 24, wherein at least one pair of said emission directions are non-parallel with respect to each other.

27. An apparatus as claimed in claim 24, wherein each of said sources emits a spatially dispersing beam in a first plane and relatively narrow in a second plane perpendicular to said first plane.

28. An apparatus as claimed in claim 27, wherein said first plane is substantially upright.

29. An apparatus as claimed in claim 21, wherein said electromagnetic radiation detector comprises a plurality of photodetectors each having a known detection direction, wherein the direction of a reflection event is determinable from said known detection directions.

30. An apparatus as claimed in claim 29, wherein said electromagnetic radiation detector comprises three of more photodetectors each having a known detection direction.

31. An apparatus as claimed in clam 29, wherein each of said plurality of photodetectors has a detection region that is relatively broad in a first plane and relatively narrow in a second plane perpendicular to said first plane.

32. An apparatus as claimed in claim 21, including at least one modulator for modulating said electromagnetic radiation so that said reflected electromagnetic radiation is correspondingly modulated, and a discriminator for discriminating between said modulated reflected electromagnetic radiation and background or other undesired electromagnetic radiation.

33. An apparatus as claimed in claim 21, including at least one DC filter for filtering said reflected electromagnetic radiation or a signal corresponding thereto, to eliminate unmodulated and therefore undesired detected electromagnetic radiation.

34. An apparatus as claimed in claim 21, wherein said apparatus is operable to detect one or more of said reflection events in the form of at least one temporal spectrum of reflected electromagnetic radiation intensity.

35. An apparatus as claimed in claim 21, wherein said emitter and said detector are located so that said reflection events are detected at respective locations in close proximity to where said electromagnetic radiation is emitted.

36. An apparatus as claimed in claim 21, wherein said emitter comprises one or more sources of electromagnetic radiation, and said detector comprises one or more photodetectors each having a known detection direction, wherein each of said one or more sources is located in close proximity to at least one of said photodetectors.

37. An apparatus as claimed in claim 36, wherein said apparatus is configured to detect reflection events due to reflection of electromagnetic radiation from a respective one of said one or more sources by means of a respective one of said photodetectors, wherein said respective one of said one or more sources and said respective one of said photodetectors are in close proximity.

38. An apparatus as claimed in claim 35, wherein said detector comprises three or more photodetectors.

39. An apparatus for measuring the speed of a moving motor vehicle, including the apparatus as claimed in claim 21.

40. A method as claimed in claim 6, wherein said first plane is substantially upright.

41. A method as claimed in claim 1, including tracking said object by determining a plurality of values, each at a different time, of the speed of said object or of the location of said object or of both the speed and location of said object.

42. A method as claimed in claim 6, wherein said beams do not all intersect along a single line.

43. A method as claimed in claim 6, including employing further beams in addition to the minimum number of beams necessary to determine said information, whereby additional information provided by said further beams is used for error checking or to improve reliability or to track said object.
